(19) United States
(12) Patent Application Publication
(10) Pub. No.: US 2025/0326514 A1
(43) Pub. Date: Oct. 23, 2025

(54) PACKAGE REMOVAL TOOL

(71) Applicant: Cristina Saldana, Indian Head Park, IL (US)

(72) Inventor: Cristina Saldana, Indian Head Park, IL (US)

(21) Appl. No.: 18/792,778

(22) Filed: Aug. 2, 2024

Related U.S. Application Data
(63) Continuation-in-part of application No. 18/598,404, filed on Mar. 7, 2024.

(51) Int. Cl. B65B 69/00

(52) U.S. Cl. CPC B65B 69/00

(57) ABSTRACT

The package removal tool described in this invention is designed for efficiently extracting disposable plastic rings, straps, or similar fasteners used to secure bulk packages. In certain embodiments, the tool features an elongated body with a tapered arm at one end, accompanied by a protrusion on the opposite side which creates a recess for securing the packaging material. A middle portion of the body may be arched thereby distributing force evenly for easier removal of packaging. This tool is particularly useful for removing plastic rings from bottles, providing a safe and effective method without risking injury or excessive force. Its ergonomic design makes it suitable for users with varying hand strengths. Overall, this package removal tool combines innovative features to simplify the process of opening and extracting packaging materials efficiently and safely.

### CLAIM FOR PRIORITY

This utility application claims priority from patent application Ser. No. 18/598,404 filed on Mar. 7, 2024.

### CROSS-REFERENCE TO RELATED APPLICATIONS:

This application is related to and incorporates by reference the disclosures of the following co-pending and commonly assigned patent application Ser. No. 18/598,404 filed on Mar. 7, 2024.

### FIELD OF THE INVENTION

This invention pertains to a handheld tool designed for package removal, particularly focusing on a package removal tool used for the safe and efficient extraction of disposable plastic rings, straps, or other fasteners employed to secure bulk packages.

### BACKGROUND OF THE INVENTION

Consumers frequently purchase goods in bulk packaging from retailers like Costco for the sake of convenience and cost-effectiveness. Often, these bulk packages contain items secured together using various securing means such as plastic rings, straps, or other fasteners to streamline handling and transportation. However, the removal of such packaging can prove cumbersome and sometimes hazardous. In particular, the removal of plastic rings, straps, or other fasteners from multipacks can pose difficulties. These securing means are commonly used to hold items together during transit, but they can present challenges when it comes to separating individual items from the packaging. The process of removing these securing means may require significant force, and the design of these securing means often provides little grip for users, making the task even more challenging.

Existing tools designed to assist with the removal of packaging fasteners often fall short in various ways. They may be ineffective for tightly secured fasteners, or they may require complex procedures that are inconvenient for users. Safety risks, such as sharp edges or points on these tools, further complicate the removal process and may deter consumers from using them altogether. Additionally, the compatibility of these tools with different types and sizes of packaging is often limited, reducing their overall utility.

In light of these challenges, there is a clear need for innovative solutions that facilitate the safe and efficient removal of packaging fasteners. By addressing these concerns, such solutions can enhance consumer convenience.

### BRIEF SUMMARY OF THE INVENTION

The present invention provides a package removal tool used for the safe and efficient extraction of disposable plastic rings, straps, or other fasteners employed to secure bulk packages. The tool includes an elongated body having a first end and a second end. The first end of the elongated body includes an arm with a base wider than a tip of the arm. The arm tapers from the base to the tip. The elongated body includes a first side and a second side. A protrusion is disposed on the first side of the elongated body opposite to the base of the arm disposed on the second side of the elongated body. A recess is created between the protrusion and the base of the arm.

In an embodiment, the elongated body has a middle portion disposed between the first end and the second end.

In another embodiment, a width of the middle portion is less than a width of the first end and a width of the second end.

In yet another embodiment, the middle portion has a first surface on the first side of the elongated body and a second surface on the second side of the elongated body, each of which are curved.

In yet another embodiment, the first surface and the second surface of the middle portion are each arched.

In yet another embodiment, the protrusion is bulbous.

In yet another embodiment, the tip of the arm is pointed.

In yet another embodiment, the arm is curved.

In yet another embodiment, a center of the elongated body is disposed in a center plane, the tip of the arm is disposed in a first plane and a top surface of the protrusion is disposed in a second plane, and the distance between the center plane and the first plane being greater than the distance between the center plane and the second plane.

In yet another embodiment, an outer surface of the second end is curved.

In yet another embodiment, an interior surface of the base of the arm forms the recess between the arm and the protrusion.

In yet another embodiment, the recess between the protrusion and the base of the arm is adapted to receive the packaging.

In yet another embodiment, the protrusion is adapted to militate against the packaging from moving toward the middle portion of the elongated body.

In yet another embodiment, a hole is formed in the second end of the elongated body.

In yet another embodiment, the hole is circular.

In yet another embodiment, a center of the elongated body is disposed in a center plane, the outer surface of the second end disposed in a third plane, the base of the arm having an exterior surface disposed in a fourth plane, and the distance between fourth plane and the center plane being greater than the distance between the center plane and the third plane.

In yet another embodiment, the elongated body is formed through 3D printing.

In yet another embodiment, the tool is made of thermoplastic or metal.

A method for removing packaging using a tool is provided. The method includes providing the tool that includes an elongated body having a first end and a second end. The first end of the elongated body includes an arm. A base of the arm is wider than a tip of the arm. The arm tapers from the base to the tip. The elongated body has a first side and a second side. A protrusion is disposed on the first side opposite of the base of the arm disposed on the second side. A recess is created between the protrusion and the arm. The method includes inserting the tip of the tool between the packaging and a product and leveraging the tool against the product, thereby removing the packaging from the product. In specific embodiments, tool is inserted between a hard plastic ring and a bottle, and the tool is leveraged against a cap of the bottle, thereby pulling the ring up to release the hard plastic ring handle from the bottle.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating.

FIG. 1 shows a rear perspective view of a package removal tool according to various embodiments of the present invention.

FIG. 2 is a top perspective view of the package removal tool.

FIG. 3 is a bottom perspective view of the package removal tool.

FIG. 4 is a side elevational view of the package removal tool showing the variety of widths formed in an elongated body.

FIG. 5 is a side elevational view of the package removal tool showing a variety of surfaces disposed in different planes.

FIG. 6 shows the tool of FIG. 1 inserted into the packaging of a bottle.

FIG. 7 shows the tool of FIG. 1 in the process of removing the packaging from the bottle.

FIG. 8 shows the tool of FIG. 1 having removed the packaging from the bottle.

Like reference numerals refer to like parts throughout the several views of the drawings.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence of addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the invention and the claims. A package removal tool is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

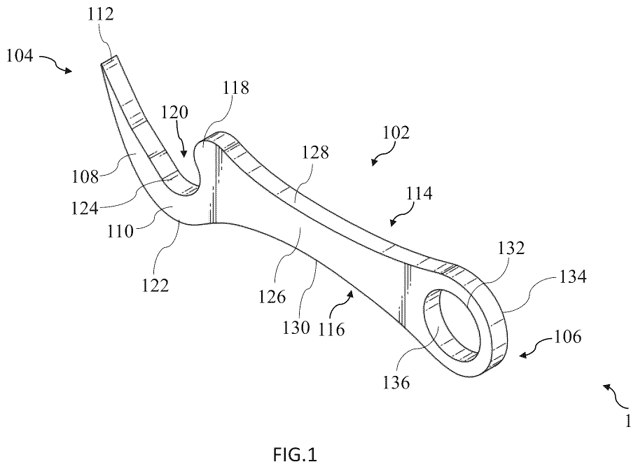

FIG. 1 shows a rear perspective view of a package removal tool 1 according to various embodiments of the present invention. The tool 1 includes an elongated body 102 having a first end 104 and a second end 106. The first end 104 of the elongated body 102 includes an arm 108 with a base 110 wider than a tip 112 of the arm 108. In certain embodiments, the arm 108 tapers from the base 110 to the tip 112. In further embodiments, the arm 108 may curve from the base 110 to the tip 112. However, it should be appreciated that other shapes of the arm 108 may be chosen by a skilled artesian as desired, for example, the arm 108 may be straight, curved, angled, telescoping, modular, ergonomic, ribbed, contoured, knurled, offset, twisted, tapered, or segmented. The elongated body 102 includes a first side 114 and a second side 116. A protrusion 118 is disposed on the first side 114 of the elongated body 102 opposite to the base 110 of the arm 108 disposed on the second side 116 of the elongated body 102. A recess 120 is created between the protrusion 118 and the base 110 of the arm 108. The arm 108 includes an exterior surface 122 and an interior surface 124. The interior surface 124 of the base 110 of the arm 108 forms the recess 120 between the arm 108 and the protrusion 118. The elongated body 102 has a middle portion 126 disposed between the first end 104 and the second end 106. In certain embodiments, the width of the middle portion 126 is less than the width of the first end 104 and the width of the second end 106. The middle portion 126 is shown having a first surface 128 on the first side 114 of the elongated body 102 and a second surface 130 on the second side 116 of the elongated body 102, each of which may be curved or arched. However, it should be appreciated that the elongated body 102 may have a variety of shapes, for example, the elongated body 102 may be bulbous, rectangular, circular, elliptical, triangular, square, hexagonal, octagonal, conical, cylindrical, oval, ergonomically contoured, tapered, flat, or wavy.

In certain embodiments, a hole 132 is formed in the second end 106 of the elongated body 102. An outer surface 134 of the second end 106 may be curved and an inner surface 136 of the second end 106 may be circular forming the hole 132. However, it should be appreciated that this hole 132 can be of any shape or size, including but not limited to circular, oval, rectangular, square, triangular, or irregular, and can vary in diameter or dimensions to suit specific design requirements or functional purposes. Additionally, it should be further understood that the elongated body 102 may or may not have a hole 132 formed therein.

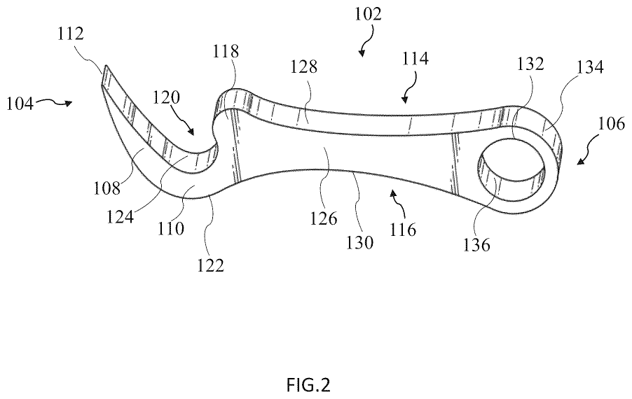

FIG. 2 is a top perspective view of the package removal tool 1 of FIG.1. The top perspective view of the tool 1 shows the elongated body 102, the first end 104, the second end 106, the arm 108, the arm base 110, the arm tip 112, the first side 114, the second side 116, the protrusion 118, the recess 120, the exterior surface 122, the interior surface 124, the middle portion 126, the first surface 128, the second surface 130, the hole 132, the outer surface 134, and the inner surface 136.

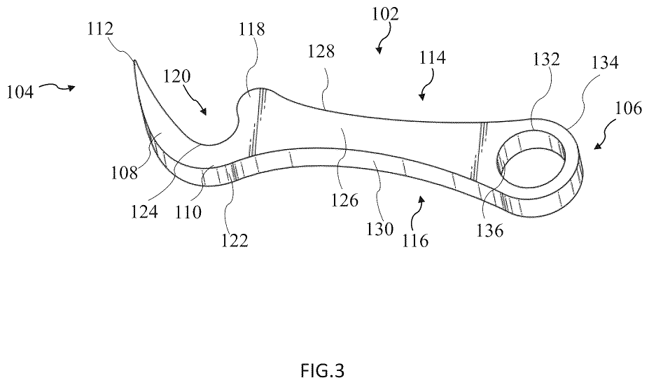

FIG. 3 is a bottom perspective view of the package removal tool 1 of FIG. 1. The bottom perspective view shows the elongated body 102, the first end 104, the second end 106, the arm 108, the arm base 110, the arm tip 112, the first side 114, the second side 116, the protrusion 118, the recess 120, the exterior surface 122, the interior surface 124, the middle portion 126, the first surface 128, the second surface 130, the hole 132, the outer surface 134, and the inner surface 136.

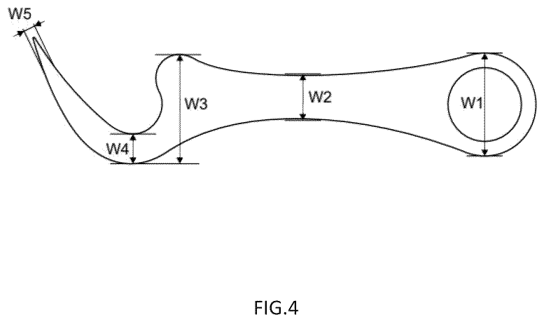

FIG. 4 is a side elevational view of the package removal tool 1 showing the variety of widths formed in an elongated body 102. W1 is the width of the second end 106. In certain embodiments, the width of the second end 106 may be between 15 and 35 mm, and may be approximately 25 mm in preferred embodiments. W2 is the width of the middle portion 126. In certain embodiments, the width of the middle portion 126 may be between 7.5 and 25 mm, and may be approximately 15 mm in preferred embodiments. W3 is the width of the tool 1 between the protrusion 118 and the arm base 110. In certain embodiments, the width between the protrusion 118 and the arm base 110 may be between 46.5 and 66.5 mm, and may be approximately 56.5 mm in preferred embodiments. W4 is the width of the tool 1 between the recess 120 and the arm base 110. In certain embodiments, the width between the recess 120 and the arm base 110 may be between 10 and 30 mm, and may be approximately 20 mm in preferred embodiments. W5 is the width of the arm tip 112. In certain embodiments, the width of the arm tip 112 may be between 4 and 12 mm, and may be approximately 8 mm in preferred embodiments.

In certain embodiments, the length of the tool 1 between the first end 104 and the second end 106 may be between 161.25 and 181.25 mm, and may be approximately 171.25 mm in preferred embodiments. In certain embodiments, the height of the tool 1 between the arm tip 112 and the arm base 110 may be between 32.45 and 52.45 mm, and may be approximately 42.45 mm in preferred embodiments. In certain embodiments, the length of the tool 1 between the arm base 110 and inner surface 136 of the hole 132 may be between 80 mm and 140 mm, and may be approximately 90 mm in preferred embodiments.

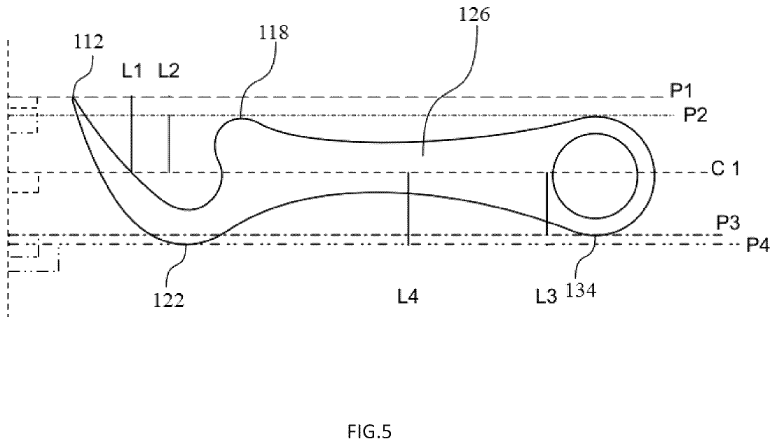

FIG. 5 is a side elevational view of the package removal tool 1 showing a variety of surfaces disposed in different planes. The side elevational view of the package removal tool 1 shows the arm tip 112, the protrusion 118, the middle portion 126, the exterior surface 122, and the outer surface 134. P1 is a first plane, P2 is a second plane, P3 is a third plane, P4 is a fourth plane and C1 is a center plane. In certain embodiments, the center of the elongated body 102 is disposed in the center plane C1, the arm tip 112 is disposed in the first plane Pl and a top surface of the protrusion 118 is disposed in the second plane P2, and the distance between the center plane C1 and the first plane PI being greater than the distance between the center plane C1 and the second plane P2. In certain embodiments, the outer surface of the second end 106 is disposed in the third plane P3, the arm base 110 having the exterior surface 122 is disposed in the fourth plane P4, and the distance between fourth plane P4 and the center plane C1 being greater than the distance between the center plane C1 and the third plane P3. In certain embodiments, a length L1, the distance between C1 and P1, may be between 11.78 and 31.78 mm, and may be approximately 21.78 mm in preferred embodiments. In certain embodiments, a length L2, the distance between C1 and P2, may be between 8.25 and 26.50 mm, and may be approximately 16.50 mm in preferred embodiments. In certain embodiments, a length L3, the distance between C1 and P3, may be between 7.50 and 27.50 mm, and may be approximately 17.50 mm in preferred embodiments. In further embodiments a length L4, the distance between C1 and P4, may be between 10 and 30 mm, and may be approximately 20 mm in preferred embodiments.

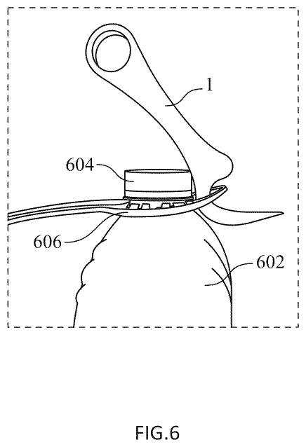

A method for removing the packaging using the tool 1 may include inserting the arm tip 112 of the tool 1 between a product and the packaging and leveraging the tool 1 against the product and pushing down on the tool 1, thereby removing the packaging from the product. For example, as shown in FIGS. 6-8, the tool I may be inserted between a hard plastic ring handle 606, 706, 806 and a bottle 602, 702, 802, where the tool 1 is leveraged against a cap 604, 704, 804 of the bottle 602, 702, 802, thereby pulling the packaging up to release the hard plastic ring handle 606, 706, 806 from the bottle 602, 702, 802.

FIG. 6 shows the tool 1 of FIG.1 inserted into the packaging of the product. FIG. 6 shows the bottle 602, the cap 604, and the hard plastic ring handle 606.

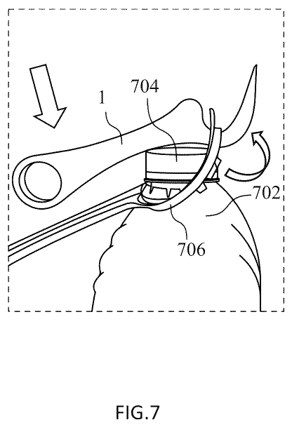

FIG. 7 shows the tool 1 of FIG. 1 in the process of removing the packaging from the bottle 702 by exerting a downward force on the tool 1, where the hard plastic ring handle 706 is disposed in the recess and abutting the protrusion 118. FIG. 7 shows the bottle 702, the cap 704, and the hard plastic ring handle 706.

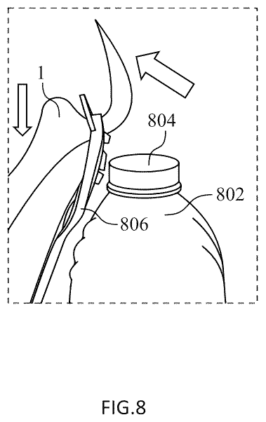

FIG. 8 shows the tool 1 of FIG. 1 having removed the packaging from the bottle. FIG. 8 shows the bottle 802, the cap 804, and the hard plastic ring handle 806.

The package removal tool 1 shown in FIGS. 1-8 may be used for removing various securing means such as plastic rings, straps, or other fasteners from a variety of products, including bottles 602, 702, 802. In certain embodiments, the arm 108 tapers from the base 110 to the tip 112 resulting in a pointed or beveled edge, which enables the arm 108 to easily separate the packaging from a product. In certain embodiments, as shown in FIGS. 6-8, the tip 112 may be inserted between the product 602, 702, 802 and the packaging 606, 706, 806. The tool 1 may then be leveraged against the product 602, 702, 802 to remove the packaging 606, 706, and 806. Specifically, as shown in FIGS. 1-8, the arm 108 may be curved to efficiently separate the packaging. It should be further appreciated that the curvature of the arm 108 functions to hold the packaging 606, 706, and 806 in the recess 120 between the protrusion 118. This is shown in FIGS. 6, where the arm 108 is inserted from above and the tip 112 is pointing outward next to the cap 604 of the bottle 602. The protrusion 118 on the elongated body 102 militates against the packaging from traveling up the elongated body 102 to the middle portion 126 where as user likely has their hand. This militation against the packaging is shown in FIGS. 6-8, where the ring handle 606 is disposed in the recess of the tool 1 and is stopped by the protrusion 118 from moving further up the elongated body 102 toward the middle portion 126. Notably, the tool 1 is designed for a user to leverage a minimum amount of force without risking slipping or injury. Specifically, in certain embodiments as shown in FIGS. 1-8, the middle portion 126 may be arched in shape, which enhances efficiency by distributing the force evenly, thereby facilitating an easier and more effective package removal. For example, the tool 1 may be advantageous to people with hand-strength issues, where they cannot exert the same amount of force as a person with normal hand strength. This design minimizes effort and increases effectiveness in opening packaging. The tool 1 may also include the hole 132 at the second end 106, which may be designed to hang the tool 1 in storage, or clip the tool 1 onto a tool belt or clip for safe travel.

While the present invention has been described in terms of particular embodiments and applications, in both summarized and detailed forms, it is not intended that these descriptions in any way limit its scope to any such embodiments and applications. It will be understood that many substitutions, changes and variations in the described embodiments, applications and details of the method and system illustrated herein and of their operation can be made by those skilled in the art without departing from the spirit of this invention.

What is claimed is:

1. A tool for removing packaging, wherein the tool comprises:
an elongated body having a first end and a second end;
the first end of the elongated body having an arm, wherein a base of the arm is wider than a tip of the arm and the arm tapers from the base to the tip, and
the elongated body having a first side and a second side, wherein a protrusion is disposed on the first side of the elongated body opposite to the base of the arm disposed on
the second side of the elongated body, wherein a recess is created between the protrusion and the base of the arm.

2. The tool of claim 1, wherein the elongated body has a middle portion disposed between the first end and the second end.

3. The tool of claim 2, wherein a width of the middle portion is less than each of a width of the first end and a width of the second end.

4. The tool of claim 2, wherein the middle portion has a first surface on the first side of the elongated body and a second surface on the second side of the elongated body, each of which are curved.

5. The tool of claim 4, wherein in the first surface and the second surface of the middle portion are each arched,

6. The tool of claim 1, wherein the protrusion is bulbous.

7. The tool of claim 1, wherein the tip of the arm is pointed.

8. The tool of claim 7, wherein the arm is curved.

9. The tool of claim 1, wherein a center of the elongated body is disposed in a center plane, the tip of the arm is disposed in a first plane and a top surface of the protrusion is disposed in a second plane, and the distance between the center plane and the first plane being greater than the distance between the center plane and the second plane.

10. The tool of claim 1, wherein an outer surface of the second end is curved.

11. The tool of claim 1, wherein an interior surface of the base of the arm forms the recess between the arm and the protrusion.

12. The tool of claim 1, wherein the recess between the protrusion and the base of the arm is adapted to receive the packaging.

13. The tool of claim 15, wherein the protrusion is adapted to militate against the packaging from moving toward the middle portion of the elongated body.

14. The tool of claim 1, wherein a hole is formed in the second end of the elongated body.

15. The tool of claim 14, wherein the hole is circular,

16. The tool of claim 15, wherein a center of the elongated body is disposed in a center plane, the outer surface of the second end disposed in a third plane, the base of the arm having an exterior surface disposed in a fourth plane, and the distance between fourth plane and the center plane being greater than the distance between the center plane and the third plane.

17. The tool of claim 1, wherein the elongated body is formed through 3D printing.

18. The tool of claim 1, wherein the tool is composed of thermoplastic or metal.

19. A method for removing packaging using a tool, wherein the method comprises:
providing the tool that includes an elongated body having a first end and a second end, the first end of the elongated body having an arm, wherein a base of the arm is wider than a tip of the arm, wherein the arm tapers from the base to the tip, the elongated body having a first side and a second side, wherein a protrusion is disposed on the first side opposite of the base of the arm disposed on the second side, wherein a recess is created between the protrusion and the arm;
inserting the tip of the tool between a product and the packaging; and
leveraging the tool against the product and pushing down on the tool, thereby removing the packaging from the product.

20. The method of claim 15, wherein the tool is inserted between a hard plastic ring and a bottle, and the tool is leveraged against a cap of the bottle, thereby pulling the ring up to release the hard plastic ring handle from the bottle.
